(19) United States
(12) Patent Application Publication
(10) Pub. No.: US 2013/0187876 A1
(43) Pub. Date: Jul. 25, 2013

(54) DETECTOR, DETECTION METHOD AND DISPLAY DEVICE

(71) Applicant: JAPAN DISPLAY WEST INC., AICHI-KEN (JP)

(72) Inventor: Keiichiro Ishihara, Kanagawa (JP)

(73) Assignee: JAPAN DISPLAY WEST INC., AICHI-KEN (JP)

(21) Appl. No.: 13/722,525

(22) Filed: Dec. 20, 2012

(30) Foreign Application Priority Data
Jan. 25, 2012 (JP) 2012-012611

(51) Int. Cl. G06F 3/041

(52) U.S. Cl. CPC G06F 3/041
USPC 345/173

(57) ABSTRACT

Disclosed herein is a detector including: a plurality of signal lines provided in a user operation area; an injection section adapted to inject a pulse signal into the plurality of signal lines; and a determination section adapted to detect a reflected signal of the pulse signal reflected from an impedance-mismatched area of the signal line and determine the position of the signal line operated by the user based on the time at which the reflected signal is detected.

### CROSS REFERENCES TO RELATED APPLICATIONS

The present application claims priority to Japanese Priority Patent Application JP 2012-012611 filed in the Japan Patent Office on Jan. 25, 2012, the entire content of which is hereby incorporated by reference.

### BACKGROUND

The present disclosure relates to a detector, detection method and display device, and more particularly, to a detector, detection method and display device suitable for detecting the position operated on the screen display.

A touch panel, for example, is superimposed on the display of a tablet personal computer or smartphone to permit the user to enter various operations simply by touching the screen. Existing touch panels are based on one of a variety of methods including resistance film method and static capacitance method.

In any of the touch panels in related art, it has been necessary to arrange two types of electrodes, namely, those adapted to detect the horizontal coordinate (x coordinate) of the display and others adapted to detect the vertical coordinate (y coordinate) of the display, in a matrix form so as to detect the position operated by the user, thus resulting in a complicated electrode structure.

For this reason, the present applicant has proposed the diversion of the drive electrodes of the display for use as the electrodes adapted to detect the horizontal coordinate (x coordinate) of the touch panel or those adapted to detect the vertical coordinate (y coordinate) of the touch panel (refer to Japanese Patent Laid-Open No. 2009-244958, hereinafter referred to as Patent Document 1). The present disclosure allows reduction of the number of electrodes in the entire display having a touch panel.

### SUMMARY

However, even the disclosure described in Patent Document 1 remains unchanged in terms of having the electrodes adapted to detect the x coordinate and those adapted to detect the y coordinate arranged in a matrix form so as to detect the position operated by the user. As a result, more simplification of the electrode structure is desired.

In light of the foregoing, it is desirable to allow detection of the position operated by the user by using a simpler electrode structure.

A detector according to a first mode of the present disclosure includes a plurality of signal lines, injection section and determination section. The plurality of signal lines are provided in a user operation area. The injection section injects a pulse signal into the plurality of signal lines. The determination section detects a reflected signal of the pulse signal reflected from an impedance-mismatched area of the signal line and determines the position of the signal line operated by the user based on the time at which the reflected signal is detected.

The plurality of signal lines can be arranged linearly and parallel to each other.

The plurality of signal lines can be arranged linearly and parallel to each other in the longitudinal direction of the operation area.

The determination section can detect a reflected signal of the pulse signal reflected from an impedance-mismatched area of the signal line and determine the plurality of positions of the signal line operated by the user based on the times at which the reflected signal is detected.

A detection method according to the first mode of the present disclosure is a detection method of a detector adapted to detect the position operated by the user and includes an injection step and determination step. The injection step injects a pulse signal into a plurality of signal lines provided in a user operation area using the detector. The determination step detects a reflected signal of the pulse signal reflected from an impedance-mismatched area of the signal line and determines the position of the signal line operated by the user based on the time at which the reflected signal is detected.

In the first mode of the present disclosure, a pulse signal is injected into a plurality of signal lines arranged in a user operation area, a reflected signal of the pulse signal reflected from an impedance-mismatched area of the signal line is detected, and the position of the signal line operated by the user is determined based on the time at which the reflected signal is detected.

A display device according to a second mode of the present disclosure includes a display, a plurality of signal lines, injection section and determination section. The display displays an image. The plurality of signal lines are superimposed on the display. The injection section injects a pulse signal into the plurality of signal lines. The determination section detects a reflected signal of the pulse signal reflected from an impedance-mismatched area of the signal line and determines the position of the signal line operated by the user based on the time at which the reflected signal is detected.

In the second mode of the present disclosure, a pulse signal is injected into the plurality of signal lines superimposed on the display, a reflected signal of the pulse signal reflected from an impedance-mismatched area of the signal line is detected, and the position of the signal line operated by the user is determined based on the time at which the reflected signal is detected.

The first mode of the present disclosure allows detection of the position operated by the user in a user operation area by using a simpler electrode structure.

The second mode of the present disclosure allows detection of the position operated by the user on a display surface by using a simpler electrode structure.

Additional features and advantages are described herein, and will be apparent from the following Detailed Description and the figures.

### BRIEF DESCRIPTION OF THE FIGURES

FIG. 1 is a schematic diagram for describing the principle of the impedance measurement using a reflected wave;

FIGS. 2A to 2E are diagrams illustrating measured voltages in impedance measurement using a reflected wave;

FIG. 3 is block diagram illustrating a configuration example of a TDR measurement section shown in FIG. 1;

FIG. 4 is a diagram illustrating a measured voltage for FIG. 3;

FIG. 5 is a diagram illustrating the change in impedance resulting from touching a single line;

FIG. 6 is a diagram illustrating a measured voltage for FIG. 5;

FIG. 7 is a block diagram illustrating a configuration example of a position detector to which the present disclosure is applied;

FIG. 8 is a diagram illustrating a configuration example when the plurality of position detectors are applied to a display;

FIGS. 9A to 9C are cross-sectional views when the position detector is applied to the display;

FIGS. 10A and 10B are diagrams for describing an operated position when the position detector is applied to the display;

FIG. 11 is a diagram illustrating another configuration example when the plurality of position detectors are applied to the display;

FIGS. 12A and 12B are diagrams illustrating the chronological change in impedance resulting from touching one location of the signal line; and

FIGS. 13A and 13B are diagrams illustrating the chronological change in impedance resulting from touching two locations of the signal line.

### DETAILED DESCRIPTION

A description will be given below of the best mode for carrying out the present disclosure (hereinafter referred to as the embodiments).

A description will be given first of the principle behind the impedance measurement using a reflected wave (hereinafter referred to as the TDR (Time Domain Reflectometry) measurement).

<Principle of the TDR Measurement>

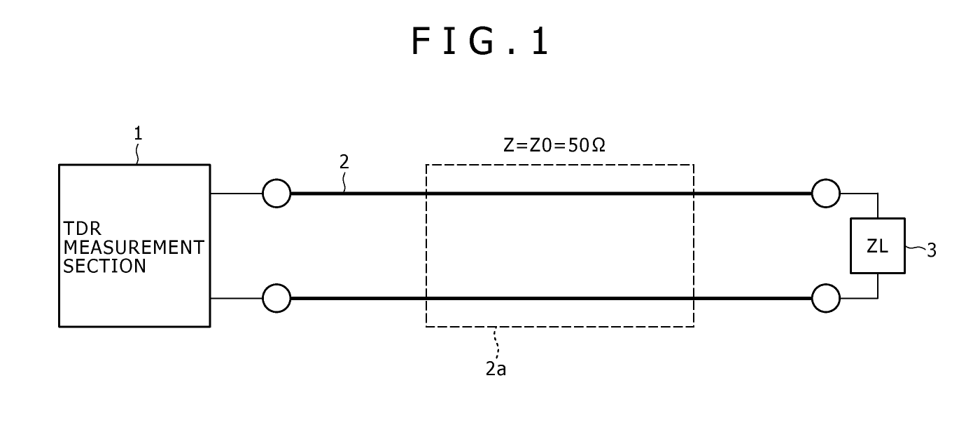

FIG. 1 is a schematic diagram for describing the principle of the TDR measurement using a reflected wave.

A signal line 2 is connected to a TDR measurement section 1. A distributed constant circuit 2a of the signal line 2 has a characteristic impedance Z0=50Ω, and the end of the same circuit 2a not connected to the TDR measurement section 1 is terminated with a sample 3 having an impedance ZL. The TDR measurement is designed to measure the impedance of the sample based on a reflected wave from an impedance-mismatched area of the signal line 2.

More specifically, the TDR measurement section 1 injects a quickly rising pulse signal into the signal line 2 which is considered as the distributed constant circuit 2a (having the impedance Z0). An impedance ZL=Z0(1+ρ)/(1−ρ) is calculated based on ρ=Er/Ei, i.e., the ratio between an injected voltage Ei of the pulse signal and the voltage of a reflected pulse signal (reflected voltage Er).

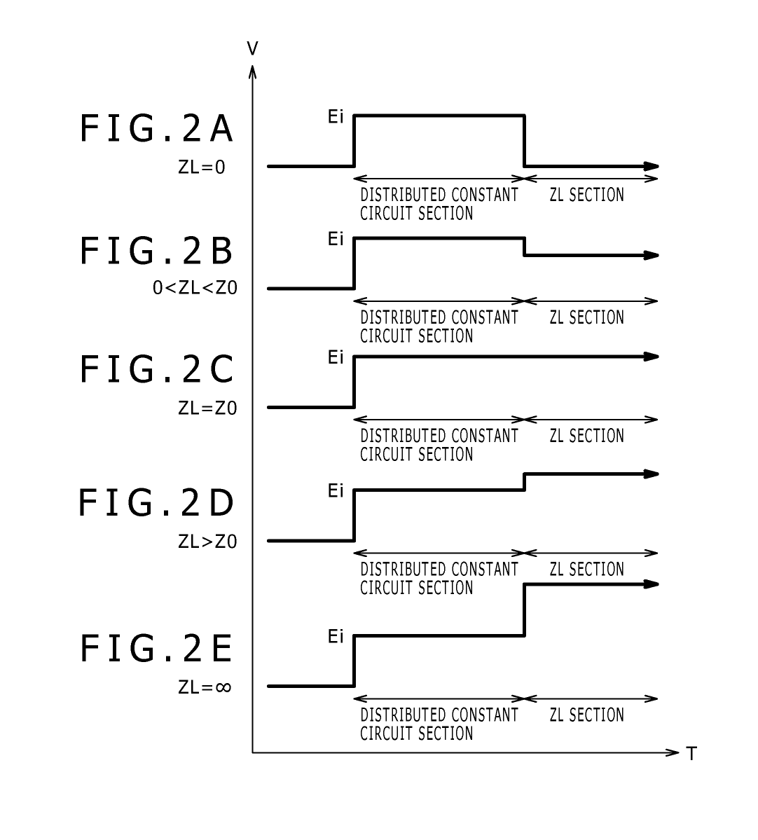

FIGS. 2A to 2E illustrate the chronological change in the voltage V (injected voltage Ei+reflected voltage Er) measured by the TDR measurement section 1, with the horizontal axis representing time T and the vertical axis the voltage V. As illustrated in FIGS. 2A to 2E, the voltage V equal to the injected voltage Ei is measured for the distributed constant circuit section.

FIG. 2A illustrates a case in which the impedance ZL of the sample 3 is zero. In this case, the voltage V is measured to be zero for the ZL section.

FIG. 2B illustrates a case in which the impedance ZL of the sample 3 is greater than zero but smaller than Z0. In this case, a voltage smaller than the injected voltage Ei is measured as the voltage V for the ZL section.

FIG. 2C illustrates a case in which the impedance ZL of the sample 3 is equal to Z0. In this case, the voltage Ei equal to the injected voltage is measured as the voltage V for the ZL section.

FIG. 2D illustrates a case in which the impedance ZL of the sample 3 is greater than Z0. In this case, a voltage greater than the injected voltage Ei is measured as the voltage V for the ZL section.

FIG. 2E illustrates a case in which the end of the signal line 2 is open, that is, the impedance ZL is infinite. In this case, a voltage 2Ei, twice the injected voltage, is measured as the voltage V for the ZL section.

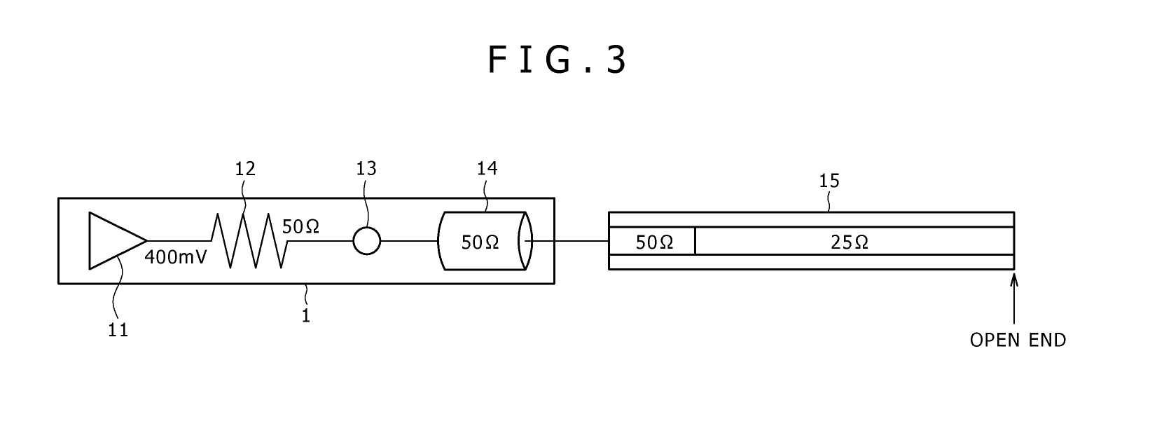

Next, FIG. 3 illustrates a configuration example of the TDR measurement section 1. The same section 1 includes a pulse generator 11, resistor 12 and coaxial cable 14 that are connected in series. A voltage measurement point 13 is provided between the resistor 12 and coaxial cable 14.

The pulse generator 11 generates a quickly rising 400 mV pulse signal. The impedance of each of the resistor 12 and coaxial cable 14 is 50Ω.

A signal line 15 connected to the TDR measurement section 1 includes two distributed constant circuits, i.e., a 50Ω circuit and 25Ω circuit, as illustrated in FIG. 3. The end of the TDR measurement section 1 is open.

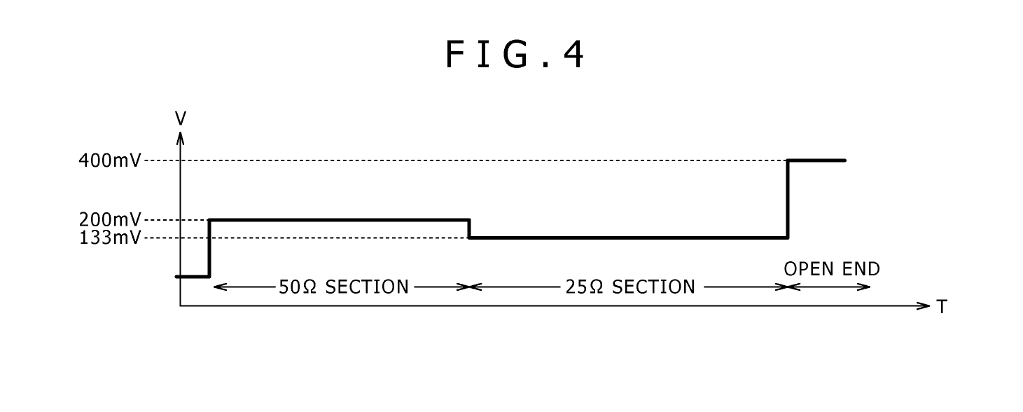

FIG. 4 illustrates the chronological change in the measured voltage V for FIG. 3, with the horizontal axis representing the time T and the vertical axis the voltage V. In this case, 200 mV is measured for the 50Ω section, 133 mV for the 25Ω section, and 400 mV for the open end.

It is clear from FIG. 4 that if the signal line 15 is considered as a plurality of distributed constant circuits having difference impedances, the measured voltage changes at the boundary therebetween.

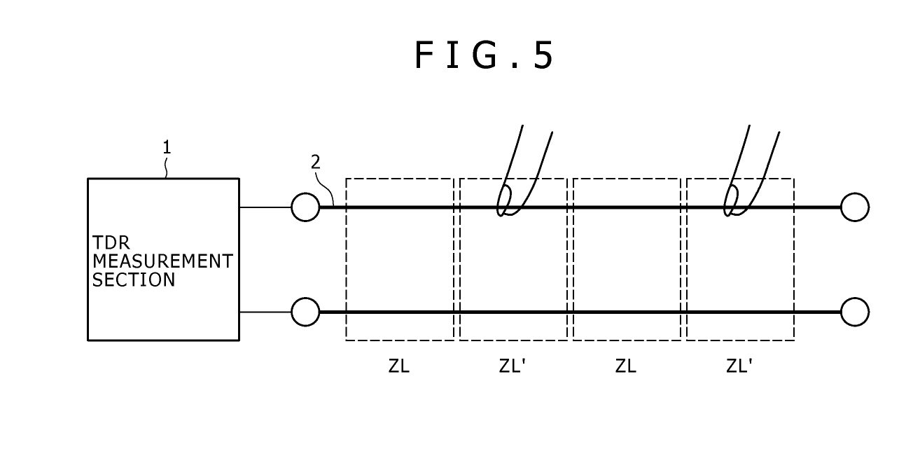

Next, FIG. 5 illustrates that if the signal line is considered as a plurality of distributed constant circuits, each having the impedance ZL, this impedance changes to ZL′ (<ZL) when a conductive substance such as a human finger touches (may only approach) one of the distributed constant circuits.

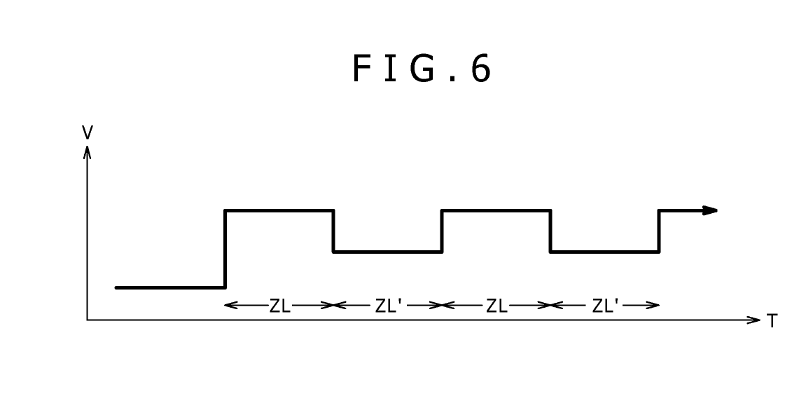

As is clear from the result of FIG. 4, the measured voltage changes at the boundary between the plurality of distributed constant circuits having different impedances. As illustrated in FIG. 5, the measured voltage V changes also when the impedance changes because of a human finger. The chronological change in the measured voltage V for FIG. 5 is as illustrated in FIG. 6. Therefore, if the time T at which the measured voltage V changes is identified, it is possible to measure the position of the signal line touched by the finger.

The present disclosure describes, as the embodiment, a position detector adapted to detect the position operated by the user by taking advantage of the fact that the measured voltage changes as a result of a human finger touching a signal line made up of a plurality of distributed constant circuits.

[Configuration Example of the Position Detector]

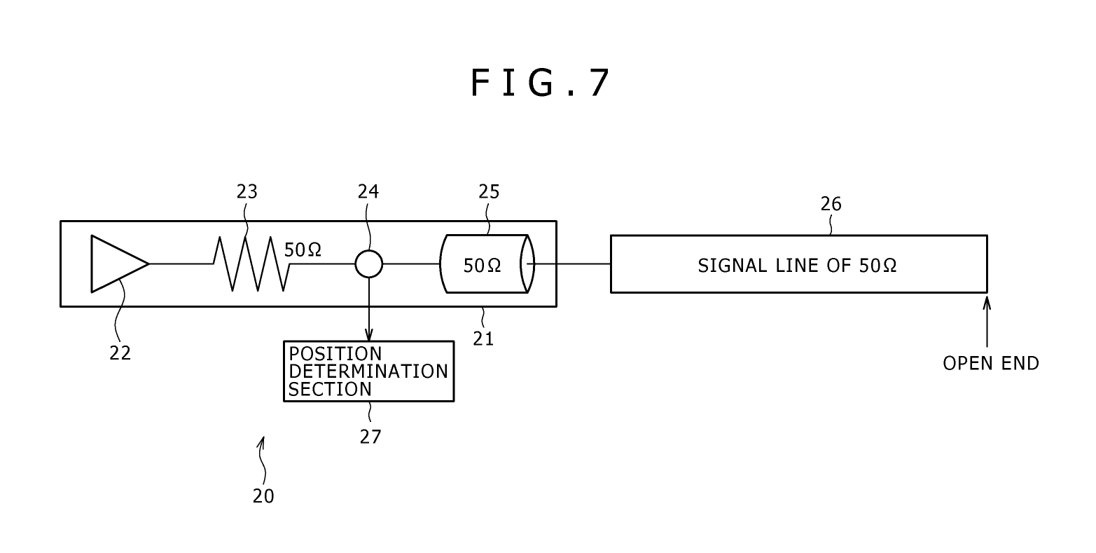

FIG. 7 illustrates a configuration example of a position detector to which the present disclosure is applied.

A position detector 20 includes a TDR measurement section 21, signal line 26 and position determination section 27. The TDR measurement section 21 includes a pulse generation section 22, resistor 23 and coaxial cable 25 that are connected in series. A voltage measurement point 24 is provided between the resistor 23 and coaxial cable 25.

The signal line 26 has its one end, i.e., the end not connected to the TDR measurement section 21, left open. The same line 26 may be made of any metal. However, it is preferred that the same line 26 should have a high conductance. The position determination section 27 measures the voltage at the measurement point 24 and detects the time T at which the measured voltage V changes, thus determining the position of the signal line 26 touched, for example, by the user's finger based on the time T at which the measured voltage V changes. It should be noted that the position determination section 27 stores, in advance, a correspondence table and function indicating the correspondence between the time T at which the measured voltage V changes and the operated position.

It should be noted that the measured voltage V changes when not only a human finger but also other conductive substance touches or approaches the signal line 26. Therefore, the position operated, for example, by a stylus pen or other conductive substance rather than a human finger can be determined Further, the position touched or approached by an insulator can also be determined, albeit with lower accuracy.

### Application of the Position Detector to the Display

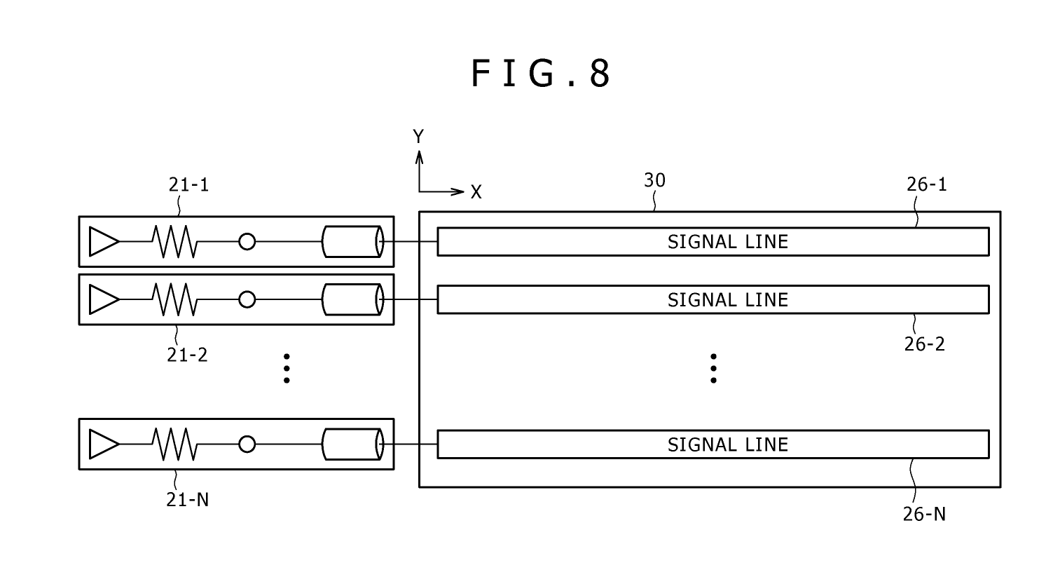

The position detector 20 determines only the one-dimensional position of the signal line 26. In order to determine the two-dimensional position of a display, therefore, it is only necessary to have ready the plurality of position detectors 20 and arrange the plurality of signal lines 26 thereof parallel to the x- or y-axis direction of the display 20 as illustrated in FIG. 8. It should be noted that FIG. 8 illustrates a case in which the plurality of signal lines 26 of the plurality of position detectors 20 are arranged parallel to the x-axis direction of a display 30.

As illustrated in FIG. 8, it is possible to provide higher accuracy in determining the signal line position by arranging the plurality of signal lines 26 parallel to the longitudinal direction of the display (x-axis direction in this case) than arranging them vertically relative to the longitudinal direction of the display.

It should be noted that the plurality of signal lines 26 may not be linear and parallel to each other. For example, the same lines 26 may be bent at a given angle at the edge of the display.

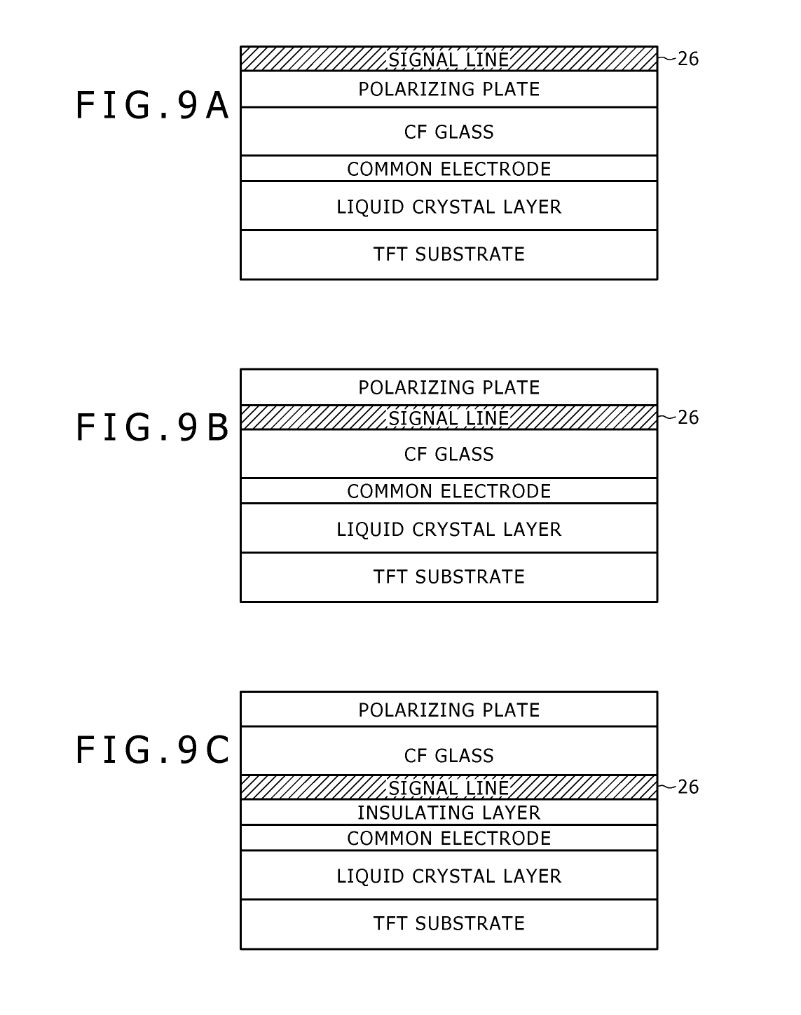

FIGS. 9A to 9C illustrate three examples of cross-sectional views illustrating the arrangement of the signal lines 26 when the position detector 20 is applied to the display. FIG. 9A illustrates an example in which the signal lines 26 are provided at the uppermost layer. FIG. 9B illustrates an example in which the signal lines 26 are provided between the polarizing plate and CF glass. FIG. 9C illustrates an example in which the signal lines 26 are provided between the CF glass and insulating layer.

Alternatively, the signal lines 26 may serve as electrodes against ESD (Electrostatic Discharge) in the display.

### Description of the Operation

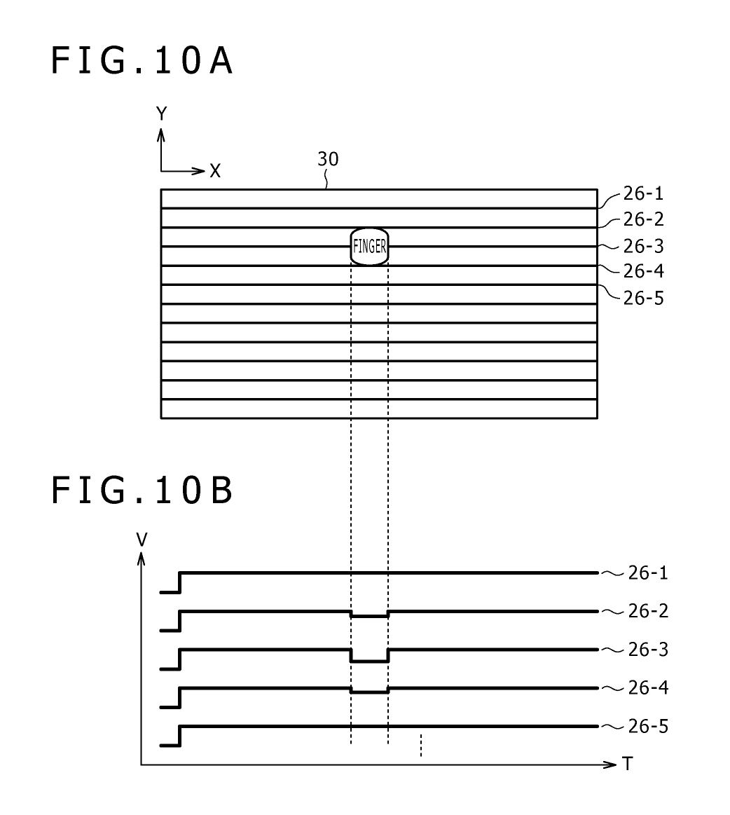

A description will be given next of the operation adapted to determine the two-dimensional position of the display by using the plurality of position detectors 20 with reference to FIGS. 10A and 10B. It should be noted that FIG. 10A is a simplified version of FIG. 8, and FIG. 10B illustrates the chronological change in the measured voltage for FIG. 10A.

If the user's finger touches the display 30 as illustrated in FIG. 10A, the impedance of the signal line 26 close to the finger changes, thus resulting in the chronological change in the voltage V measured from this signal line 26 close to the finger. The voltages V measured from the other signal lines 26 do not change. In this case, therefore, the x coordinate of the operated position is detected based on the time T at which a change takes place in the only voltage V of all the voltages V that changes. Further, the y coordinate of the operated position is detected based on the arrangement of the signal line 26 whose voltage is the only voltage V of all the voltages V that changes.

It should be noted that the number of operated positions that can be detected is not just one. Instead, a plurality of positions can be simultaneously detected.

### Modification Example

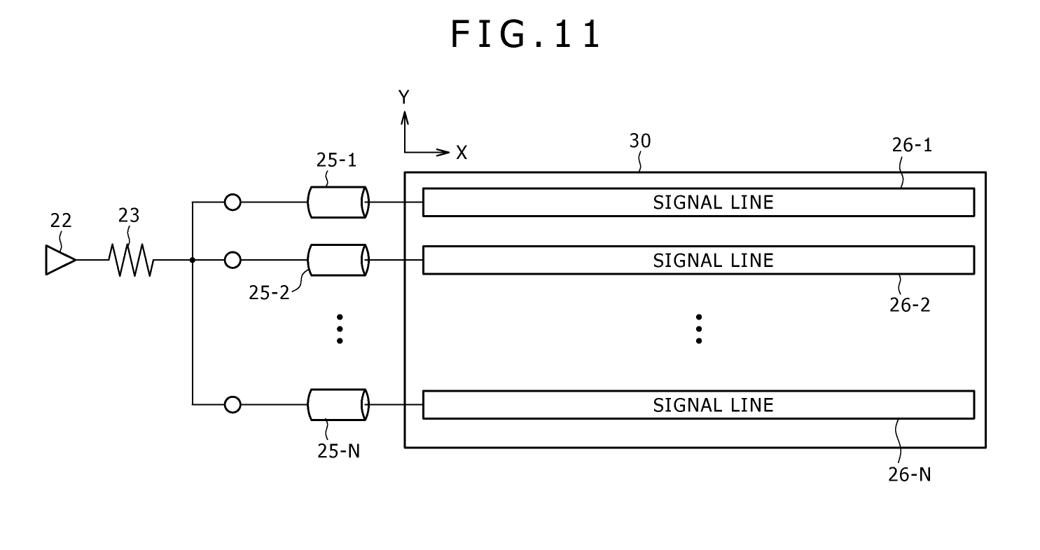

It should be noted that if the plurality of position detectors 20 are applied to the display 30, the single pulse generation section 22 and single resistor 23 may be provided as illustrated in FIG. 11 to distribute a signal among the plurality of signal lines 26 rather than providing as many TDR measurement sections 21 as the number of the signal lines 26 as illustrated in FIG. 8. This contributes to reduced overall scale of the circuitry of the plurality of position detectors 20.

### Other Operation Example

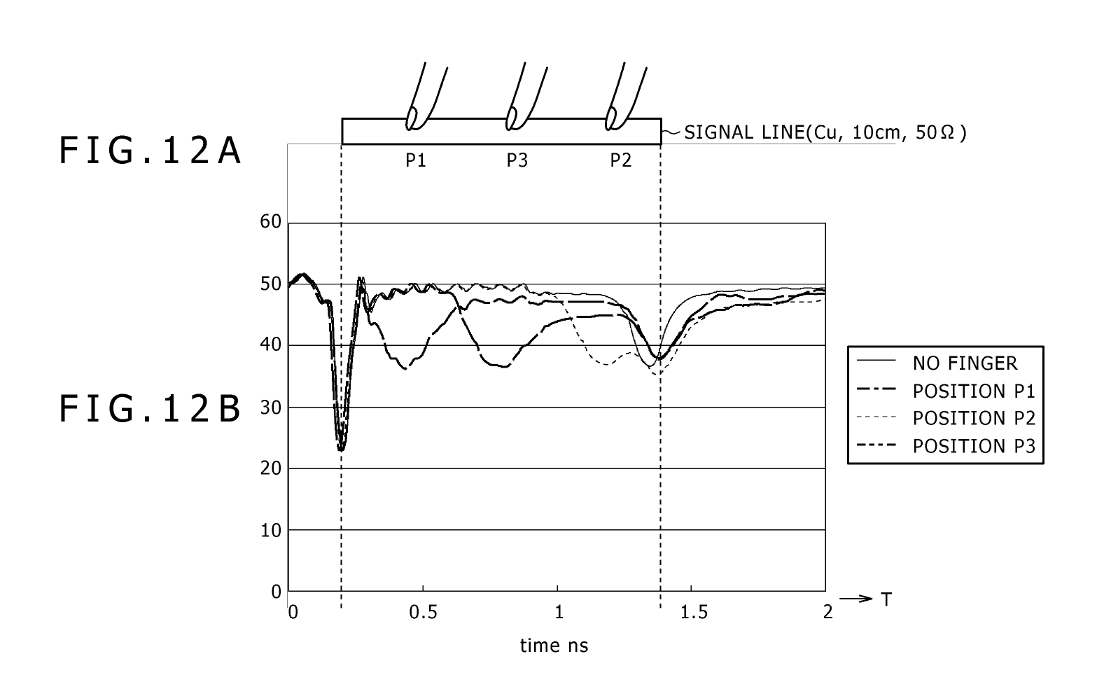

FIGS. 12A and 12B illustrate the chronological change in an impedance Z of a signal line resulting from touching positions P1, P2 and P3 of the signal line, with the horizontal axis representing the time t and the vertical axis the impedance Z. It should be noted that the signal line is made of copper and 10 cm in length and has the characteristic impedance Z0 of 50Ω, and that the end of the signal line not connected to the TDR measurement section 21 is terminated with 50Ω.

As illustrated in FIGS. 12A and 12B, it is clear that, irrespective of which of the positions P1, P2 and P3 of the signal line is touched, there is a time in which the impedance Z changes as compared to when none of the above positions is touched (Z0=50Ω). We can also notice that the time t at which the impedance Z changes varies depending on the touched position, i.e., position P1, P2 or P3. Therefore, it is possible to determine the operated position by detecting the time t at which the impedance Z changes.

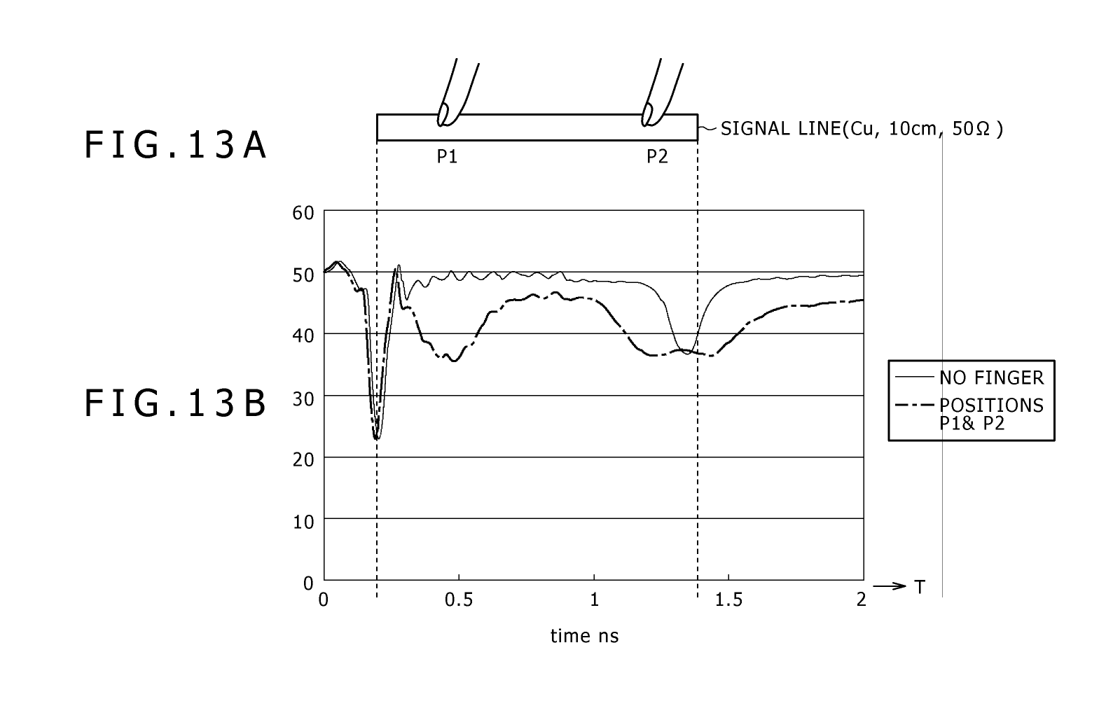

FIGS. 13A and 13B illustrate the chronological change in the impedance Z of a signal line resulting from simultaneously touching the positions P1 and P2 of a signal line, with the horizontal axis representing the time t and the vertical axis the impedance Z. It should be noted that the signal line is made of copper and 10 cm in length and has the characteristic impedance Z0 of 50Ω, and that the end of the signal line not connected to the TDR measurement section 21 is terminated with 50Ω.

As illustrated in FIGS. 13A and 13B, it is clear that when the positions P1 and P2 of the signal line are touched, there are times in which the impedance Z changes significantly as compared to when none of the above positions is touched (Z0=50Ω). It is also clear, by comparison with FIGS. 12A and 12B, that these times coincide respectively with the touches on the positions P1 and P2. This makes it possible to determine the plurality of simultaneously touched positions by detecting the plurality of times t at which the impedance Z changes.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A detector comprising:
a plurality of signal lines provided in a user operation area;
an injection section adapted to inject a pulse signal into the plurality of signal lines; and
a determination section adapted to detect a reflected signal of the pulse signal reflected from an impedance-mismatched area of the signal line and determine the position of the signal line operated by the user based on the time at which the reflected signal is detected.

2. The detector of claim 1, wherein
the plurality of signal lines are arranged linearly and parallel to each other.

3. The detector of claim 2, wherein
the plurality of signal lines are arranged linearly and parallel to each other in the longitudinal direction of the operation area.

4. The detector of claim 2, wherein
the determination section detects a reflected signal of the pulse signal reflected from an impedance-mismatched area of the signal line and determines the plurality of positions of the signal line operated by the user based on the times at which the reflected signal is detected.

5. A detection method of a detector for detecting the position operated by the user, the detection method comprising:
using the detector to inject a pulse signal into a plurality of signal lines provided in a user operation area; and
using the detector to detect a reflected signal of the pulse signal reflected from an impedance-mismatched area of the signal line and determine the position of the signal line operated by the user based on the time at which the reflected signal is detected.

6. A display device comprising:
a display adapted to display an image;
a plurality of signal lines superimposed on the display;
an injection section adapted to inject a pulse signal into the plurality of signal lines; and
a determination section adapted to detect a reflected signal of the pulse signal reflected from an impedance-mismatched area of the signal line and determine the position of the signal line operated by the user based on the time at which the reflected signal is detected.
